(19) United States
(12) Patent Application Publication
(10) Pub. No.: US 2013/0172495 A1
(43) Pub. Date: Jul. 4, 2013

(54) FUEL PART

(71) Applicants: Konraad Dullaert, Heverlee (BE); Katarina Tomic, Roermond (NL)

(72) Inventors: Konraad Dullaert, Heverlee (BE); Katarina Tomic, Roermond (NL)

(21) Appl. No.: 13/577,487

(22) PCT Filed: Feb. 3, 2011
(86) PCT No.: PCT/EP2011/051573

§ 371 Date: Dec. 11, 2012

(30) Foreign Application Priority Data
Feb. 8, 2010 (EP) 10152897.4

(51) Int. Cl. C08L 77/06; C08G 69/26

(52) U.S. Cl. CPC C08L 77/06; C08G 69/26
USPC 525/432; 264/328.1; 264/523; 528/335

(57) ABSTRACT

This invention relates to a fuel part, comprising a polymer composition comprising at least 1 wt % with respect to the total weight of polymer in the polymer composition of a component A, being an aliphatic, semi-crystalline, polyamide which has as building blocks diamines with at least 2 carbon atoms and at most 5 carbon atoms and diacids with at least 10 carbon atoms. The invention also relates to a process for preparation of such fuel part.

This invention relates to a fuel part comprising a polymer composition and a process for preparing such fuel part.

Fuel parts are known and for example made from a polymer composition. WO2009/119759 describes a fuel part made of a composition which consists of polyamide-6, with a terminal amino group concentration higher than the terminal carboxyl group concentration, talcum and dispersant.

For safety and environment protection, there has conventionally been a demand for reducing the amount of fuel permeating through a fuel part. Fuel parts according to WO2009/119759 have the drawback that the fuel permeability of the polymer composition is still high.

It is an object of the present invention to provide fuel parts in which the fuel permeation of the polymer composition in the fuel part is reduced.

It now has surprisingly been found that a fuel part, comprising a polymer composition comprising at least 1 wt % with respect to the total weight of polymer in the polymer composition of a component A, being an aliphatic, semi-crystalline, polyamide which has as building blocks diamines with at least 2 carbon atoms and at most 5 carbon atoms and diacids with at least 10 carbon atoms, shows decreased fuel permeability compared to a polymer composition not comprising such polyamide.

This has been exemplified in examples that are listed below.

The term “fuel” is here understood as comprising various mixtures of hydrocarbons used as fuel in internal combustion or high-compression engines. Thus, this term in particular encompasses fuel oil, diesel oil and all categories of petrol, as well as mixtures of hydrocarbons and alcohols, or the like.

Fuel parts are here understood parts that can be in contact with fuel, such as fuel containers, fuel canisters, fuel caps, and fuel hoses. Fuel containers are herein understood means for containing fuel. Suitably, the container has one or more openings, suited for either separately or combined filling and/or releasing fuel.

“Semi-crystalline polyamide” is here understood to encompass a polyamide having crystalline and amorphous regions.

In one embodiment of the invention, the fuel part is a monolithic or monolayer part. Examples are housings of a fuel pump, tabs and monolayer fuel container. Production methods such as injection molding, roto-molding and blow-molding are known to provide monolayer fuel parts. This has the advantage that the method for production is simple and allows for high degree of design freedom. A fuel part according to the invention being a monolayer, has the advantage that either the fuel permeability is lower or that the monolayer can be thinner to achieve the same fuel permeability. Another advantage of a monolayer part is that the fuel permeation is more homogeneous and that no pinching occurs.

In another embodiment of the invention, the fuel part is a multilayer part. Examples of multilayer parts are multilayer fuel containers, multilayer fuel canister and multilayer fuel hoses. Multilayer fuel parts are usually made by blow-molding or by extrusion. One or more layers are then made from the polymer composition comprising at least 1 wt % with respect to the total weight of polymer in the polymer composition of component A. A multilayer fuel part has the advantage that the properties of various layers can be advantageously combined. Other layers might include high density poly ethylene (HDPE), ethylene vinyl alcohol (EVOH), tie-layers which are beneficial for various reasons. HDPE has a positive influence on impact, moisture absorption and chemical resistance. EVOH is known for its low fuel permeation. Tie-layers are used for their overall strength. Another advantage of a multilayer fuel part according to the invention is that the decreased fuel permeation of the polymer composition allows either for a simplified design of the fuel part, such as thinner layers, or less layers, or a lower fuel permeation of the whole fuel part.

A polymer composition is here understood to be a composition in which component A is present and optionally one or more other polymers, here denoted as component B. Component B includes thermoplastic polymers, such as polyethylene, polypropylene and polyamides.

In one embodiment, component B is linear. This is beneficial for injection molding, as usually linear polymers have lower viscosity which allows for better filling of the mold.

In another embodiment, component B is branched. Branched polymers typically have high molecular weight, e.g. at least 100.000, which is beneficial for blow molding. This allows for better parison stability and results in more equal wall thickness.

Preferably component B is one or more polyamides, more preferably linear, semi-crystalline polyamides, such as for example polyamide-6, polyamide-66 or polyamide-46, or polyamide-12.

Component A can for example be PA-210, PA-410 and PA-510, PA-212, PA-412 and PA-512, PA-214, PA-414 and PA-514, in which “PA” stands for “polyamide”.

Polyamides made from a diamine and diacid are usually denoted as AABB resin, see for example Nylon Plastics Handbook, Edited by Melvin I. Kohan, Hanser Publishers, 1995, page 5. The nomenclature is adhered to as used in Nylon Plastics Handbook; e.g. PA-612 denotes a homopolymer with building blocks hexane-1,6-diamine and dodecanedioic acid, PA-6/12 denotes a copolymer made from ε-caprolactam and laurolactam and a blend of PA-6 and PA-12 is described as PA-6/PA-12.

Preferably, component A is a linear polyamide, as these polyamides are usually less amorphous and exhibit less fuel permeation.

Preferably the diacids have at most 14 carbon atoms. The melting temperature increases with decreased number of carbon atoms of both diamines and diacids and this has a positive influence on the mechanical properties. When the carbon atoms of the diamines are in the range of 2 to 5 and the carbon atoms of the diacid are in the range of 10 to 14 the fuel permeability and the melting temperature are at an optimum.

Preferably, the diacid of component A, is decanedioic acid, such as for example PA-210, PA-410 or PA-510. Fuel parts comprising a polymer composition comprising these polyamides exhibit very low fuel permeability combined with high impact resistance at cold temperatures, e.g. at −30° C. More preferably PA-410 or PA-510 are used, as these polyamides exhibit a good water resistance.

Preferably, the diamine of component A, is butane-1,4-diamine, such as for example PA-410, PA-412 and PA-414 as this allows for high peak temperature resistance of the fuel part.

Even more preferably component A is PA-410, in other words has butane-1,4-diamine as diamine and decanedioic acid as diacid. When component A is PA-410 the fuel permeation is even lower than with respect to PA-610 as well as higher peak temperature resistance with respect to PA-610.

The fuel part according to the invention comprises a polymer composition comprising at least 1 wt % with respect to the total weight of polymer in the polymer composition of component A. It has surprisingly been found that a fuel part according to the invention showed lower fuel permeability compared to the fuel part not comprising component A even when component A is present in relatively low amounts, such as for example in amounts of at least 1 wt %, preferably 2 wt %, more preferably 3 wt % and even more preferably 4 wt % with respect to the total weight of polymer in the polymer composition.

More preferably the polymer composition comprises at least 10 wt %, relative to the total weight of polymer in the polymer composition of component A. Even more preferably the polymer composition comprises at least 20 wt %, relative to the total weight of polymer in the polymer composition of component A.

The advantage of higher amounts of component A is that the fuel permeation of the polymer composition is even lower, and/or that the design of the fuel part can be simplified while retaining the same fuel permeation.

The fuel part according to the invention preferably has a fuel permeation of CE10 fuel of at most 4 g mm/m2 per day at 40° C., more preferably 2.5 and even more preferably 0.5 g mm/m2 per day at 40° C.

Another advantage is that the fuel part according to the invention is less susceptible for ethanol in fuels. It has been shown that the ratio of fuel permeation of CE20/CE10 fuels is less than 1.5 g mm/m2 per day at 40° C. when the amount of component A is at least 60 wt % with respect to the total weight of polymer in the polymer composition. More preferably, the amount of component A is at least 70 wt % with respect to the total weight of polymer in the polymer composition, as this results in an even lower ratio of fuel permeation of CE20/CE10 fuels.

When the fuel part comprises a polymer composition comprising at least 95 wt % with respect to the total weight of polymer in the polymer composition of component A, it has surprisingly been found that the fuel tank has an even lower fuel permeability ratio for CE20/CE10 fuels. More preferably, the fuel part comprises a polymer composition comprising at least 98 wt % with respect to the total weight of polymer in the polymer composition of component A.

Preferably, the polymer composition comprises component A and at least 30 wt % of polyamide-6 with respect to the total weight of polymer in the polymer composition. This has as advantage that the fuel permeation remains lower than is expected based on the fuel permeability of polyamide-6 alone and on the fuel permeability of component A alone. More preferably the polymer composition comprises at least 40 wt % polyamide-6 and even more preferably at least 50 wt % polyamide-6. A blend of polyamide-6 and component A has a synergistic effect in that the fuel permeability remains low, while the cost prize also remains relatively low, whereas the mechanical properties remain sufficient. Another advantage is that the fuel permeability of the composition can be adjusted to legal demands by varying the amount of component A compared to polyamide-6, without having to adjust the design of the fuel part.

More preferred, the polymer composition comprises component A wherein the diamine is butane-1,4-diamine and the diacid is decanedioic acid, in other words PA-410 and at least 30 wt % of polyamide-6 with respect to the total weight of polymer in the polymer composition, more preferably at least 40 wt % polyamide-6 and even more preferably at least 50 wt % polyamide-6. This gives better welding properties in case of injection molding. It also reduces the fuel permeability of the polymer composition, while keeping the cost price low.

An additional advantage of a fuel part according to the invention is that the cold temperature impact resistance properties remain sufficient

Fuel parts can be made with known processes, such as injection-molding or blow-molding.

Injection molding is here understood to comprise the following steps:
a. heating a composition comprising component A and optionally component B to obtain a viscous liquid;
b. filling a mold cavity with the viscous liquid;
c. leaving the viscous liquid in the mold under pressure until it cools and solidifies to form a part;
d. opening the mold;
e. ejecting the part.

Blow-molding is here understood to comprise at least the following steps:
a. heating a composition comprising component A and optionally component B to obtain a viscous liquid;
b. forming a parison from the viscous liquid;
c. expand the parison by pressurized gas and press it against a mold cavity until it cools and solidifies to form a part;
d. opening the mold;
e. ejecting the part.

Fuel parts preferably have a good impact resistance at low temperature, which is measured at −30° C. with ASTM norm D4272. Various impact modifiers may be present in the fuel part according to the invention.

Examples of suitable impact modifiers are rubber-like polymers that not only contain apolar monomers such as olefins, but also polar or reactive monomers such as, among others, acrylates and epoxide, acid or anhydride containing monomers. Examples include a copolymer of ethylene with (meth)acrylic acid or an ethylene/propylene copolymer functionalized with anhydride groups. The advantage of such additives is that they do not only improve the impact strength of the polymer composition but also contribute to an increase in viscosity.

The fuel part according to the invention can optionally comprise reinforcing agents. Reinforcing agents, such as glass fibers, have the advantage that the fuel permeability is further decreased. Reinforcing agents however, have the drawback that the density of the composition is increased, which is undesirable. The weight of many fuel parts, e.g. fuel tank in outdoor power products (leave blower, trimmer), need to be reduced as far as possible for ergonomics considerations of the end-user. It has surprisingly been found that the fuel part according to the invention preferably have lower amounts of fillers, as the fuel permeability is reduced by the presence of component A, which usually has a lower density than fillers.

Suitable fillers are mineral fillers such as clay, mica, talc, glass spheres. Reinforcing fibres are for example glass fibres. As reinforcing fibres the polyamide composition preferably comprises 5-50 wt % glass fibres, relative to the total polymer composition, more preferably 10-45, and most preferably 15-40 wt % glass fibres. Suitable glass fibres generally have a diameter of 5-20 micron, preferably 8-15 micron, and are provided with a coating suitable for use in polyamide. An advantage of a polymer composition comprising glass fibres is its increased strength and stiffness, particularly also at higher temperatures, which allows use at temperatures up to close to the melting point of the polymer in a polymer composition.

The invention will now be elucidated by examples, without the wish to be limited hereto.

### EXAMPLES

### Methods

The fuel permeation rate was measured by the weight loss method according to ASTM E96BW in which water has been replaced by ASTM fuel CE10 (composed of 10 vol. % ethanol and 90 vol. % of ASTM fuel C (50/50 wt % mixture of toluene and iso-octane)). The fuel permeation measurements were performed at 40° C. under dry conditions. The standard deviation in this method is between 5 and 10%. Weight percentages are denoted with respect to the total weight of polyamide, unless stated otherwise. Results are shown in Table 1.

The fuel uptake measurements were performed by immersing a polymer plaque of known thickness in the fuel CE10 and studying weight increase with the time. At the beginning of experiment weight was measured more frequently (every hour) and after first day, measurements were performed once a day. Plaques of 1 mm thickness with a surface of 4×4 cm were used. This method allowed to obtain overall diffusivity (D), overall solubility (S) and to determine in indirect way fuel permeability (P).

Fuel permeation rate is determined by the amount of fuel uptake (solubility) and the speed of uptake (diffusion):

P=D*S (1)

For platelet geometry it has been known that the relative weight uptake at short times is a linear function of square root of time and can be described with the simplified equation:

$$\frac{{M}_{t} - {M}_{0}}{{M}_{∞} - {M}_{0}} = {( \frac{4 Dt}{π} )}^{0.5} \cdot \frac{1}{L}$$

### Where:

Mₜ—weight at time t
M₀—initial weight of dry plaque (at time zero)
M_{∞}—weight of swollen plaque (at infinite time)
L—half-thickness of a plaque

In this way diffusivity can be calculated from the slope of the graph.

Overall solubility (S) can be obtained from the total weight uptake (at infinite time) and is defined:

$$S = \frac{{M}_{∞} - {M}_{0}}{{M}_{0}} \cdot 100$$

In such a way determined solubility is expressed in percents, meaning amount of fuel dissolved in 100 g of polymer. From solubility and diffusivity, an overall permeability can be calculated according to eq. 1. In Table 2 the results for fuel uptake measurements are shown.

### Polyamides Used:

### Component A:

PA-410, polyamide which has as building blocks butane-1,4-diamine and decanedioic acid, unfilled, Mₙ=18000

### Component B:

I PA-6, unfilled, Mₙ=28000
II PA-6, unfilled, Mₙ=15000
PA-610, polyamide which has as building blocks hexane-1,6-diamine and decanedioic acid, unfilled, Mₙ=16000

### Compositions

Compositions were prepared from polyamides as mentioned in the tables below. From these compositions test plaques were prepared. The plaques had a thickness of 1 mm and a diameter of 5 cm. Fuel uptake measurements were performed at room temperature.

TABLE 1
Fuel permeation rate

| | wt % | wt % | Fuel permeation in |
|---|---|---|---|
| Composition | Component A | Component B | gmm/m2 day |
| Comparative-A | 0 PA-410 | 100 I PA-6 | 4.7 |
| 1 | 50 PA-410 | 50 I PA-6 | 1.6 |
| 2 | 100 PA-410 | 0 | 1.4 |
| Comparative-B | 0 PA-410 | 100 II PA-6 | 5.9 |
| 3 | 1 PA-410 | 99 II PA-6 | 3.2 |
| 4 | 2 PA-410 | 98 II PA-6 | 3.5 |
| 5 | 10 PA-410 | 90 II PA-6 | 3.7 |
| 6 | 20 PA-410 | 80 II PA-6 | 3.7 |
| 7 | 35 PA-410 | 65 II PA-6 | 3.7 |
| 8 | 50 PA-410 | 50 II PA-6 | 3.7 |
| 9 | 100 PA-410 | 0 | 1.4 |
| Comparative-C | 0 PA-410 | 100 PA-610 | 6.2 |

The examples clearly show that polymer compositions according to the invention comprising component A, being here PA-410, show a decreased fuel permeation (see Composition 1-9 compared to comparative examples A-C). For example, composition 1 shows a reduction of the fuel permeation to 1.6 gmm/m2 day, which is a factor 3 lower than the fuel permeation without PA-410 (comparative-A).

Compositions 3 and 4 clearly show reduced fuel permeation while low amounts of PA-410 were employed. Composition 5, where 10% of PA-410 was employed shows a reduction of a factor 1.6 compared to Comparative-B.

The compositions according to the invention also show a decreased fuel permeation with respect to a composition of PA-610 (compare compositions 1-9 with Comparative-C).

These examples clearly show that the presence of component A, being here PA-410, in a polymer composition has a positive effect on the fuel permeation and thus lowers the fuel permeation.

TABLE 2
Fuel uptake measurements

| | wt % polyamide, and | Fuel permeability |
|---|---|---|
| Composition | type of polyamide | [gmm/m²day] |
| 10 | 100% PA-410 | 1.3 |
| Comparative-D | 100% PA-610 | 3.2 |
| Comparative-E | 100% II PA-6 | 7.9 |

The results in table 2 clearly indicate that on plaques made from a polymer composition comprising component A the fuel permeability as measured by fuel uptake method is almost a factor 6 lower than compared to a composition wherein polyamide 6 was used (experiment 10 compared with comparative experiment E). When compared to polyamide-610 a decrease of fuel permeation was observed of a factor 2.5 (compare composition 10 with Comparative-D).

1. Fuel part, comprising a polymer composition comprising at least 1 wt % with respect to the total weight of polymer in the polymer composition of a component A, being an aliphatic, semi-crystalline, polyamide which has as building blocks diamines with at least 2 carbon atoms and at most 5 carbon atoms and diacids with at least 10 carbon atoms.

2. Fuel part according to claim 1, in which component A is linear.

3. Fuel part according to claim 1, characterized in that the diacid with at least 10 carbon atoms is decanedioic acid.

4. Fuel part according to claim 1, characterized in that the diamine with at least 2 carbon atoms and at most 5 carbon atoms is butane-1,4-diamine.

5. Fuel part according to claim 1, characterized in that the diacid with at least 10 carbon atoms is decanedioic acid and the diamine with at least 2 carbon atoms and at most 5 carbon atoms is butane-1,4-diamine.

6. Fuel part according to claim 1, characterized in that the amount of component A is at least 70 wt % with respect to the total weight of polymer in the polymer composition.

7. Fuel part according to claim 1, in which the polymer composition further comprises at least 5 wt % with respect to the total weight of polymer in the polymer composition of a component B.

8. Fuel part according to claim 7, characterized in that component B is chosen from the group of polyamide-6, polyamide-66 or polyamide-46, and polyamide-12.

9. Process for preparation of a fuel part according claim 1, characterized in that a polymer composition comprising component A is injection-molded or blow molded.

10. Fuel part according to claim 1, characterized in that the fuel part is a monolayer part.

11. Fuel part according to claim 1, characterized in that the fuel part is a multilayer part.
